(19) United States
(12) Patent Application Publication
(10) Pub. No.: US 2020/0176917 A1
(43) Pub. Date: Jun. 4, 2020

(54) TERMINAL FITTING AND CONNECTOR PROVIDED THEREWITH

(71) Applicant: Sumitomo Wiring Systems, Ltd., Yokkaichi (JP)

(72) Inventor: Tianyu Zhou, Yokkaichi (JP)

(21) Appl. No.: 16/693,654

(22) Filed: Nov. 25, 2019

(30) Foreign Application Priority Data
Nov. 30, 2018 (JP) 2018-224417

(51) Int. Cl. H01R 13/432; H01R 13/11

(52) U.S. Cl. CPC H01R 13/432; H01R 4/185; H01R 13/11

(57) ABSTRACT

A terminal fitting (10) includes a terminal body (11) to be inserted into a cavity (61) of a housing (60), and a deflectable and deformable locking lance (28) obliquely extending from a base end part connected to an outer wall of the terminal body (11) to a tip part, the tip part being retained and locked to a wall surface of the cavity (61). A hook (36) is at the tip of the locking lance (28). A hooking portion (38) capable of contacting the hook (36) from a side opposite to a side toward which the locking lance (28) is deflected in an insertion process into the cavity (61) is connected to the outer wall of the terminal body (11).

### BACKGROUND

### Field of the Invention

The present invention relates to a terminal fitting and to a respective connector.

### Related Art

Japanese Unexamined Patent Publication No. 2017-168445 discloses a terminal fitting a locking lance. The terminal fitting is locked in a contact chamber of a housing by the locking lance, and a housing connecting part is formed on a tip of the locking lance. FIG. 2 of Japanese Unexamined Patent Publication No. 2017-168445 shows a state where a lock shoulder (reference numeral 149 in FIG. 2) of the housing connecting part is in contact with a wall (reference numeral 320 in FIG. 2) of the housing.

In the above case, external matter, such as a wire, might interfere with and be caught by the housing connecting part before the terminal fitting is accommodated in the housing. Thus, the locking lance might be inclined in an inverting direction and broken.

The invention was completed on the basis of the above situation and aims to provide a terminal fitting and connector capable of preventing the breakage of a locking lance and enhancing a holding force to a housing.

### SUMMARY

One aspect of the invention is directed to a terminal fitting with a terminal body to be inserted into a cavity of a housing. A deflectable and deformable locking lance has a base connected to an outer wall of the terminal body and extends obliquely out from the base to a tip. The tip is retained and locked to a wall surface of the cavity. A hook is connected to the tip of the locking lance, and a hooking portion is connected to the outer wall of the terminal body. The hooking portion can contact the hooked portion from a side opposite to a side toward which the locking lance is deflected during insertion into the cavity.

External matter may interfere with the tip of the locking lance before the terminal fitting is accommodated into the housing. There is concern that such interference may displace the locking lance toward the side opposite to the side toward which the locking lance is deflected in the insertion process into the cavity, and such inverted displacement could break the locking lance. However, the hook of the locking lance contacts the hooking portion connected to the outer wall of the terminal body to restrict an inverse movement of the locking lance to prevent the breakage or damage of the locking lance.

The hook may be provided substantially along a wall surface of a wall on the tip part side of the locking lance to be substantially continuous with the wall on the tip part side of the locking lance. According to this configuration, the hook can be formed relatively easily without making the structure of the locking lance particularly complicated.

The hooking portion may be provided substantially along a wall surface of the outer wall of the terminal body to be substantially continuous with the outer wall of the terminal body. According to this configuration, the hooking portion can be formed relatively easily without making the structure of the terminal body particularly complicated.

The tip of the locking lance may extend in a width direction intersecting a deflecting direction of the locking lance, and the hook may be provided substantially continuously from a wall on one widthwise end of the tip. If a pull-out force acts on the terminal fitting with the tip of the locking lance locked to the wall surface of the cavity, the hook contacts the hooking portion and is held in a locked state on the one widthwise end side of the tip of the locking lance, whereas the hook is inclined toward the one widthwise side and lifted up on the other widthwise side of the tip of the locking lance, with the result that a locking margin of the tip of the locking lance with the wall surface of the cavity can be increased. As a result, the holding force of the terminal fitting to the housing can be enhanced.

The hook may comprise at least one touching portion capable of contacting the hooking portion. The touching portion may bei arranged at least at one rearward projecting part of the hook.

The locking lance may include at least one locking edge and the touching portion may be rearward of the rear end of the locking edge.

A length of the hooking portion in the front-rear direction may be smaller than that of the touching portion in the front-rear direction.

In a natural state where, after proper insertion into the cavity, the locking lance resiliently at least partly returns, a distal end of the touching portion of the hook is arranged away from the hooking portion with a clearance defined therebetween.

The hooking portion includes at least one slit.

The invention further relates to a connector comprising a housing having at least one cavity defined therein and at least one terminal fitting as described herein.

According to the above, if a pull-out force acts on the terminal fitting in an escaping direction from the cavity after the terminal fitting is accommodated into the housing, the tip part of the locking lance is locked to the wall surface of the cavity, but an inversion movement of the locking lance is restricted by the contact of the hook with the hooking portion as in the above case. As a result, the locking lance can be locked firmly to the housing and a holding force of the terminal fitting to the housing can be enhanced.

These and other objects, features and advantages of the invention will become more apparent upon reading the following detailed description and accompanying drawings. It should be understood that even though embodiments are described separately, single features may be combined to additional embodiments.

### BRIEF DESCRIPTION OF THE DRAWINGS

FIG. 1 is a side view of a terminal fitting according to one embodiment showing a state where the terminal fitting is inserted in a cavity of a housing.

FIG. 2 is a plan view of the terminal fitting.

FIG. 3 is a front view of the terminal fitting.

FIG. 4 is a left side view of the terminal fitting.

FIG. 5 is a right side view of the terminal fitting.

FIG. 6 is a section along A-A of FIG. 5.

FIG. 7 is a development of the terminal fitting.

### DETAILED DESCRIPTION

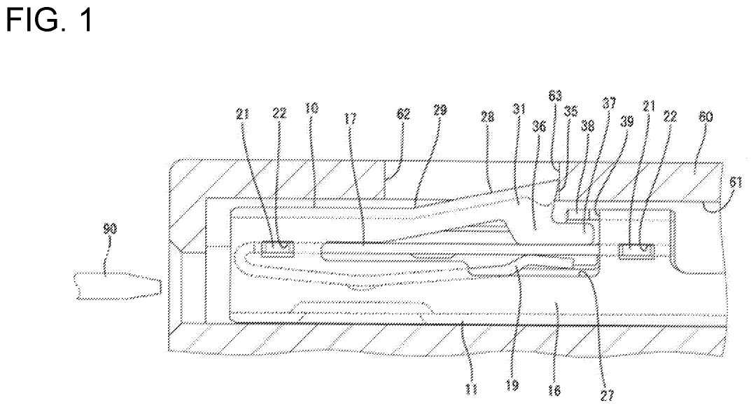

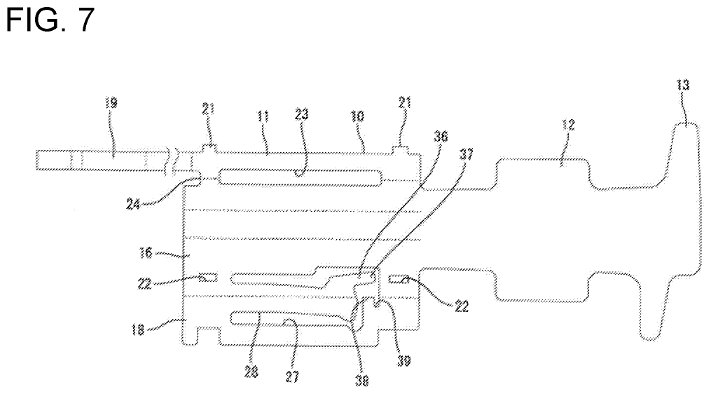

An embodiment of the invention is described with reference to FIGS. 1 to 7. A terminal fitting 10 according to this embodiment is formed integrally or unitarily by applying bending, folding, embossing or the like to a conductive metal plate is stamped or cut into a development shape shown in FIG. 7. The terminal fitting 10 is to be accommodated into a housing 60 of a connector. Note that, in the following description, a left side of FIGS. 1, 2 and 5 is referred to as a front side concerning a front-rear direction and a vertical direction is based on a vertical direction of FIGS. 1 and 3 to 6.

The housing 60 is made of synthetic resin and includes, as shown in FIG. 1, at least one cavity 61 penetrating in the front-rear direction and at least one lance receiving portion 62 at least partly intersecting and communicating with the cavity 61. Further, the housing 60 has a locking surface 63 along a direction intersecting with an insertion direction of the terminal fitting 10 into the cavity 61, particularly substantially along the vertical direction on the rear surface of the lance receiving portion 62. In this embodiment, the connector is of a non-waterproof type, and sealing members such as a sealing ring and a rubber plug are not mounted into the housing 60.

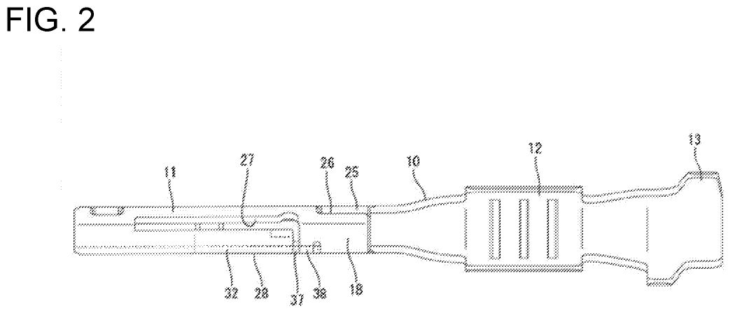

The terminal fitting 10 is a female terminal fitting that is elongated in the front-rear direction and is insertable into the cavity 61 of the housing 60 from behind. As shown in FIGS. 2, 4 and 5, the terminal fitting 10 includes a tubular terminal body 11, a wire connection portion, particularly comprising at least one wire barrel 12 in the form of an open barrel arranged rearward of the terminal body 11 and/or at least one insulation barrel 13 in the form of an open barrel rearward of the wire barrel 12. The wire barrel 12 is to be crimped, bent or deformed and connected to a core exposed by removing a coating at an end part of an unillustrated wire. The insulation barrel 13 is to be crimped or bent or deformed and connected to the coating at the end part of the unillustrated wire.

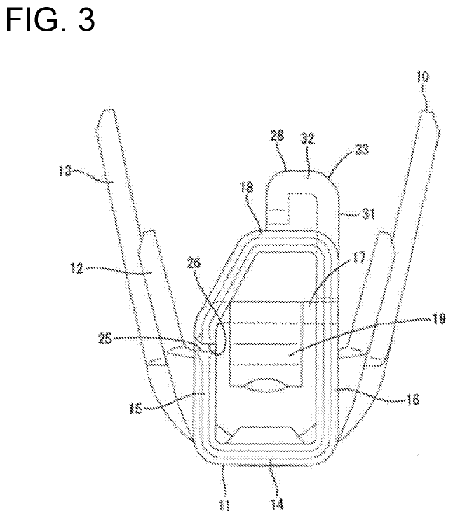

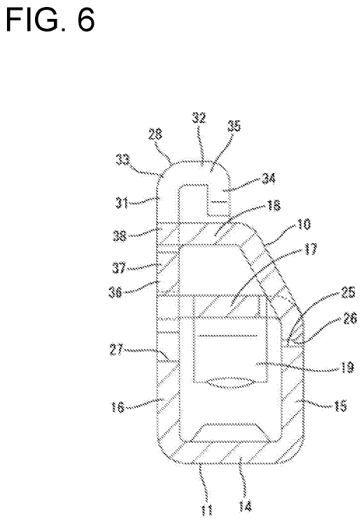

As shown in FIGS. 3 and 6, the terminal body 11 is formed into a polygonal tube shape and includes a bottom or base wall 14 continuous from the wire barrel 12 and the insulation barrel 13, first and second side walls 15, 16 rising from opposite first and second sides of the bottom wall 14, an inner ceiling wall 17 extending from an upper end of first side wall 15 to or towards the second side wall 16, and an outer ceiling wall 18 extending from an upper end of the second side wall 16 towards or to the first side wall 15 and arranged above (outside) the inner ceiling wall 17.

A contact portion 19 formed by folding a tongue (see reference numeral 19 in FIG. 7) projecting from the front end of the inner ceiling wall 17 in a developed state rearward into the terminal body 11. When the housing 60 is connected to an unillustrated mating housing, a male tab 90 (see FIG. 1) of a mating terminal fitting accommodated in the mating housing is inserted into the terminal body 11, and so that the terminal fittings are connected electrically by the resilient contact of the contact portion 19 with the male tab 90.

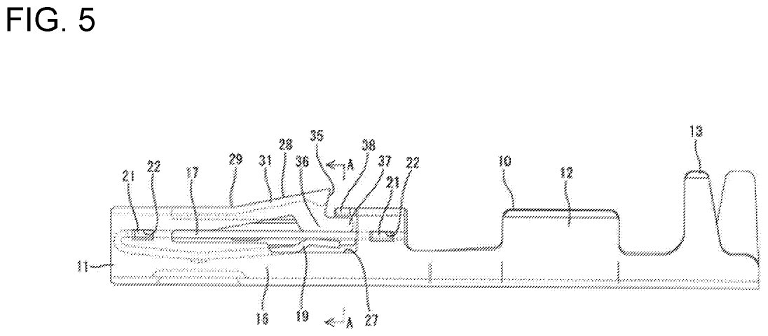

As shown in FIG. 3, the inner ceiling wall 17 is arranged substantially horizontally in a width direction. As shown in FIG. 5, the inner ceiling wall 17 includes front and rear locking projections 21 on a tip part facing toward the second side wall 16. The second side wall 16 includes front and rear locking holes 22 into which the respective locking projections 21 are inserted, at positions.

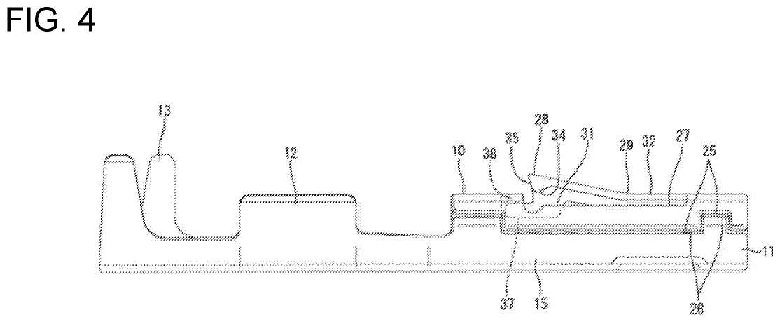

The upper or distal end of the first side wall 15 is bent via a slit 23 and a cutout 24 (see FIG. 7) between the inner ceiling wall 17 and the second side wall 15, thereby being formed as a lower step 25 having a convex-concave shape in the vertical direction, as shown in FIG. 4.

As shown in FIG. 3, the outer ceiling wall 18 is arranged to be lifted farther up or out than the inner ceiling wall 17. A part of the outer ceiling wall 18 near the one side wall 15 is arranged obliquely down toward the lower step 25 and is bent down at a position above the one side wall 15, and an upper step 26 to be fit to the lower step 25 in a convex-concave manner from above is formed on a lower or distal end part of the outer ceiling wall 18, as shown in FIG. 4.

As shown in FIG. 7, a cutout 27 in form of a loop with ends is formed in a region of the terminal body 11 from the second side wall 16 to the outer ceiling wall 18 in the developed state, and a plate inside the cutout 27 is raised up to forming a locking lance 28 extending obliquely up from a front end to a rear end, as shown in FIGS. 4 and 5. The locking lance 28 includes a fulcrum 29 serving as a starting point of inclination at a position slightly behind the front end of the cutout 27 connected to a front region of the terminal body 11, and is deflectable and deformable in the vertical direction about the fulcrum 29.

As shown in FIG. 6, the locking lance 28 includes a side plate 31 extending vertically from a surface of the second side wall 16 without any step, an upper plate 32 extending laterally at an upper end of the locking lance 28, and an arcuate bend 33 linking the side plate 31 and the upper plate 32. The side plate 31, the upper plate 32 and the bend 33 are provided over the entire length of the locking lance 28 in the front-rear direction. An extending portion 34 is on a rear end of the upper plate 32 and is bent down toward the base plate 11 from a side opposite the side plate 31.

As shown in FIG. 6, the locking lance 28 includes a locking edge 35 curved into a substantially U-shaped cross-section from the upper plate 32 to the extending portion 34 on a rear end. As shown in FIGS. 4 and 5, the locking edge 35 of the locking lance 28 is inclined rearward into a reverse tapered shape toward the upper end in a side view.

As shown in FIGS. 1 and 5, the locking lance 28 includes a hook 36 projecting down and then rearward from a rear end of the side plate 31. The hook 36 is arranged such that plate surfaces thereof extend along the front-rear direction and vertical direction, similar to the side plate 31. As shown in FIG. 6, the hook 36 is provided along a plate surface of the side plate 31 to be continuous with the side plate 31 in the width direction (plate thickness direction) without any step. As shown in FIGS. 1 and 5, a rearward projecting part of the hook 36 serves as a touching portion 37 capable of contacting a hooking portion to be described later, and the lower end thereof is arranged along the front-rear direction at the same height as the upper ends of the cutout 27 and the inner ceiling wall 17 in a front region (region forward of the fulcrum 29) of the locking lance 28. The rear end of the touching portion 37 is rearward of the rear end (upper end) of the locking edge 35.

As shown in FIG. 7, the terminal body 11 includes a hooking portion 38 at a position overlapping the hook 36 with respect to the front-rear direction in a part facing the cutout 27 in a rear part of the outer ceiling wall 18. The hooking portion 38 is in the form of a plate projecting toward one widthwise side from an edge of the cutout 27 along the front-rear direction in the rear part of the outer ceiling wall 18, and is located above the touching portion 37 of the hook 36, as shown in FIG. 6, by assembling the terminal body 11. The hooking portion 38 is arranged such that plate surfaces extend in the front-rear direction and width direction, similar to the other widthwise side of the rear part of the outer ceiling wall 18. As shown in FIG. 6, the hooking portion 38 is provided along a plate surface of the rear part of the outer ceiling wall 18 to be continuous with the rear part of the outer ceiling wall 18 in the vertical direction (plate thickness direction) without any step.

As shown in FIG. 7, the hooking portion 38 includes a slit 39 along the width direction between the hooking portion 38 and a rear edge part of the cutout 27 in the rear part of the outer ceiling wall 18. A length of the hooking portion 38 in the front-rear direction is smaller than that of the touching portion 37 in the front-rear direction.

As shown in FIGS. 4 and 5, the terminal body 11 can maintain a tubular shape by inserting the respective locking projections 21 of the inner ceiling wall 17 into the respective locking holes 22 of the second side wall 16 and fitting the upper step 26 of the outer ceiling wall 18 to the lower step 25 of the first side wall 15. The locking lance 28 is bent with the fulcrum 29 as a starting point. Thus, further bending is restricted by the contact of the upper end of the touching portion 37 of the hook 36 with the hooking portion 38. That is, a bending amount of the locking lance 28 can be specified or limited by the hooking portion 38.

There is a concern that external matter, such as a looped wire, may be caught by the locking lance 28 before the terminal fitting 10 is accommodated into the housing 60 and that the locking lance 28 may be lifted excessively, inverted forward and even plastically deformed. However, in this embodiment, a lifting movement of the locking lance 28 is restricted and the inversion of the locking lance 28 is prevented by the contact of the upper end of the touching portion 37 of the hook 36 with the hooking portion 38.

In the process of inserting the terminal fitting 10 into the cavity 61 of the housing 60, the rear upper edge of the upper plate 32 slides on the wall surface of the cavity 61 and the locking lance 28 is deflected and deformed down about the fulcrum 29. When the terminal fitting 10 is inserted properly into the cavity 61, the locking lance 28 resiliently returns and fits into the lance receiving portion 62 so that the locking edge 35 of the locking lance 28 faces and locks the locking surface 63 of the lance receiving portion 62. In this way, the terminal fitting 10 is retained in the cavity 61 (see FIG. 1). In a natural state where the locking lance 28 resiliently returns and receives substantially no pressure from the locking surface 63 of the lance receiving portion 62, the upper end of the touching portion 37 of the hook 36 is spaced from the hooking portion 38 by a tiny clearance.

If the unillustrated wire pulled rearward from the rear surface of the housing 60 is pulled after the terminal fitting 10 is inserted properly into the cavity 61, there is a concern that the locking edge 35 of the locking lance 28 may be pressed strongly against the locking surface 63 of the lance receiving portion 62 and the locking lance 28 may be lifted up along the inclination of the locking edge 35, further inverted forward and even plastically deformed. However, in this embodiment, an upward deflection of the locking lance 28 is restricted by the contact of the upper end of the touching portion 37 of the hook 36 with the hooking portion 38. As a result, inversion of the locking lance 28 is prevented.

The hook 36 is provided along the surface of the side plate 31 on the one widthwise side of the locking lance 28 to be continuous with the side plate 31 and the other widthwise side of the locking lance 28 is a free end part. Thus, if a pull-out force acts on the terminal fitting 10, such as if the wire is pulled rearward with the upper end of the touching portion 37 of the hook 36 held in contact with the hooking portion 38, the locking lance 28 can be inclined toward the one widthwise side about an axis and the other widthwise side of the locking lance 28 can be displaced up to increase a locking margin with the locking surface 63.

As described above, an inversion movement of the locking lance 28 is restricted by contact of the hook 36 of the locking lance 28 with the hooking portion 38 of the outer ceiling wall 18 when the terminal fitting 10 is accommodated in the housing 60, and also before the terminal fitting 10 is inserted into the housing 60. Thus, breakage or damage of the locking lance 28 is prevented. Furthermore, the locking lance 28 can be locked firmly to the housing 60 and a holding force of the terminal fitting 10 to the housing 60 can be enhanced.

Further, since the hook 36 is provided along the wall surface of the rear end of the side plate 31 of the locking lance 28 to be continuous with the rear end side of the side plate 31, the hook 36 can be formed easily without making the structure of the locking lance 28 complicated. In addition, since the hooking portion 38 also is provided along the wall surface of the outer ceiling wall 18 of the terminal body 11 to be continuous with the outer ceiling wall 18, the hooking portion 38 can be formed relatively easily without making the structure of the terminal body 11 complicated.

Furthermore, since the hook 36 is continuously provided from the one widthwise end side on the rear end part of the side plate 31 of the locking lance 28, if the wire is pulled rearward with the locking edge 35 of the locking lance 28 locked to the locking surface 63 of the lance receiving portion 62, the hook 36 contacts the hooking portion 38 and is held in a locked state on the one widthwise end side of the rear end part of the locking lance 28, whereas the hook 36 is inclined toward the one widthwise end side and lifted up on the other widthwise end side of the rear end part of the locking lance 28. As a result, the locking margin of the locking edge 35 of the locking lance 28 with the locking surface 63 of the lance receiving portion 62 can be increased and the holding force of the terminal fitting 10 to the housing 60 can be enhanced.

Other embodiments are briefly described below.

Two of the hooked portions may be connected to plural parts of the locking lance, e.g. to both widthwise end parts of the rear end part of the locking lance. Further, the hook may be connected to a widthwise intermediate or central part of the rear end part of the locking lance.

The hook may be structured to be kept in contact with the hooking portion in the natural state.

The terminal fitting may be a male terminal fitting including a male tab projecting forward from a terminal body. In this case, the contact portion can be omitted from the terminal body.

### REFERENCE SIGNS

10 . . . terminal fitting
11 . . . terminal body
28 . . . locking lance
31 . . . side plate
35 . . . locking edge
36 . . . hook
37 . . . touching portion
38 . . . hooking portion
60 . . . housing
61 . . . cavity
63 . . . locking surface

What is claimed is:

1. A terminal fitting (10), comprising:
a terminal body (11) to be inserted into a cavity (61) of a housing (60);
a deflectable and deformable locking lance (28) obliquely extending from a base end connected to an outer wall of the terminal body (11) to a tip, the tip being configured to be retained and locked to a wall surface of the cavity (61);
at least one hook (36) connected to the tip of the locking lance (28); and
at least one hooking portion (38) connected to the outer wall of the terminal body (11), the hooking portion (38) being capable of contacting the hook (36) from a side opposite to a side toward which the locking lance (28) is deflected in an insertion process into the cavity (61).

2. The terminal fitting of claim 1, wherein the hook (36) is provided substantially along a wall surface of a wall (31) on or near the tip of the locking lance (28) to be substantially continuous with the wall (31) on the tip of the locking lance (28).

3. The terminal fitting of claim 1, wherein the hooking portion (38) is provided substantially along a wall surface of the outer wall (18) of the terminal body (11) to be substantially continuous with the outer wall (18) of the terminal body (11).

4. The terminal fitting of claim 1, wherein the tip of the locking lance (28) extends in a width direction intersecting a deflecting direction of the locking lance (28), and the hook (36) is provided substantially continuously from a wall on one widthwise end of the tip.

5. The terminal fitting of claim 1, wherein the hook (36) comprises at least one touching portion (37) capable of contacting the hooking portion (38), the touching portion (37) being at one rearward projecting part of the hook (36).

6. The terminal fitting of claim 5, wherein the locking lance (28) includes at least one locking edge (35) and the touching portion (37) is located rearward of the rear end of the locking edge (35).

7. The terminal fitting of claim 5, wherein a length of the hooking portion (38) in the front-rear direction is smaller than that of the touching portion (37) in the front-rear direction.

8. The terminal fitting of claim 5, wherein, in a natural state where, after proper insertion into the cavity (61), the locking lance (28) resiliently returns, a distal end of the touching portion (37) of the hook (36) is arranged away from the hooking portion (38) with a clearance defined therebetween.

9. The terminal fitting of claim 1, wherein the hooking portion (38) includes at least one slit (39).

10. A connector comprising a housing (60) having a cavity (61) defined therein and the terminal fitting (10) of claim 1 insertable into the cavity (61).
